(19) United States
(12) Patent Application Publication
(10) Pub. No.: US 2023/0016465 A1
(43) Pub. Date: Jan. 19, 2023

(54) ELECTRONIC DEVICE AND SPEAKER VERIFICATION METHOD OF ELECTRONIC DEVICE

(71) Applicant: Samsung Electronics Co., Ltd., Suwon-si (KR)

(72) Inventors: Hoseon SHIN, Suwon-si (KR); Chulmin LEE, Suwon-si (KR)

(21) Appl. No.: 17/857,629

(22) Filed: Jul. 5, 2022

Related U.S. Application Data
(63) Continuation of application No. PCT/KR2022/007524, filed on May 27, 2022.

(30) Foreign Application Priority Data
Jul. 8, 2021 (KR) 10-2021-0089749

(51) Int. Cl. G10L 17/20; G10L 25/84; G10L 25/21; G10L 17/18; G10L 17/02; G10L 17/06; G10L 21/0232

(52) U.S. Cl. CPC G10L 17/20; G10L 25/84; G10L 25/21; G10L 17/18; G10L 17/02; G10L 17/06; G10L 21/0232

(57) ABSTRACT

An electronic device is provided. The electronic device includes a microphone configured to receive an audio signal including a voice of a user, a sensor configured to detect a vibration signal generated by the user, at least one processor, and a memory configured to store an instruction executable by the processor. The at least one processor may be configured to determine a noise level included in the audio signal, calculate a verification score based on the noise level, the audio signal, and the vibration signal, and perform speaker verification for the user based on the verification score.

### CROSS-REFERENCE TO RELATED APPLICATION(S)

This application is a continuation application, claiming priority under § 365(c) of an International Application No. PCT/KR2022/007524, filed on May 27, 2022, which is based on and claims the benefit of a Korean patent application number 10-2021-0089749, filed on Jul. 8, 2021, in the Korean Intellectual Property Office, the disclosure of which is incorporated by reference herein in its entirety.

### BACKGROUND

### 1. Field

The disclosure relates to an electronic device and a speaker verification method of the electronic device.

### 2. Description of Related Art

Although technology to release a lock (e.g., a screen lock) of a device through speaker verification when using a voice assistant exists, misrecognition occurs due to speaker verification performance issues. In addition, since speaker verification according to related art is performed based on an input signal of a microphone, a lock may be released even when a sound played through a speaker outside is recognized.

Various speaker verification technologies for speaker verification are being studied. Speaker verification technologies according to related art may include a gaussian mixture model (GMM), a universal background model (UBM), or a deep learning based scheme.

A speaker verification scheme according to related art may determine whether to accept/reject a speaker by determining whether the speaker is a registered speaker through an operation of extracting a feature from a voice signal and making a decision using a speaker model. However, misrecognition may occur since speaker verification is performed using only one input signal without considering noise in an external environment. Therefore, a method to increase accuracy of speaker verification by considering an external environment may be needed.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a speaker verification with improved performance by performing speaker verification using a signal detected from a microphone and an additional sensor.

Additional aspects will be set forth in part in the description which follows and, in part, will be apparent from the description, or may be learned by practice of the presented embodiments.

In accordance with an aspect of the disclosure, an electronic device is provided. The electronic device includes a microphone configured to receive an audio signal including a voice of a user, a sensor configured to detect a vibration signal generated by the user, at least one processor, and a memory configured to store an instruction executable by the at least one processor, wherein the at least one processor is configured to determine a noise level included in the audio signal, calculate a verification score based on the noise level, the audio signal, and the vibration signal, and perform speaker verification for the user based on the verification score.

In accordance with another aspect of the disclosure, an electronic device is provided. The electronic device includes a first microphone configured to receive an audio signal including a voice of a user, a processor, and a memory configured to store an instruction executable by the processor, wherein the processor is configured to receive, from a wearable device, an indication whether to allow a first permission determined by a first verification score and a second verification score calculated based on an audio signal received through a second microphone of the wearable device, a noise level included in the audio signal, and a vibration signal generated by the user, determine whether to allow a second permission based on a third verification score, and perform speaker verification based on the first permission and the second permission.

In accordance with another aspect of the disclosure, a speaker verification method of an electronic device is provided. The speaker verification method includes receiving an audio signal including a voice signal of a user, detecting a vibration signal generated by the user, determining a noise level included in the audio signal, calculating a verification score based on the noise level, the audio signal, and the vibration signal, and performing speaker verification for the user based on the verification score.

Various embodiments may improve speaker verification performance by comprehensively considering an audio signal received from a microphone and a vibration signal received from a sensor.

Various embodiments may perform high-performance speaker verification in a noisy environment by analyzing a noise level included in an audio signal and determining a type of signal to use for the speaker verification according to the noise level.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an example electronic device in a network environment according to an embodiment of the disclosure;

FIG. 2 is a block diagram illustrating an integrated intelligence system according to an embodiment of the disclosure;

FIG. 3 is a diagram illustrating a form in which concept and action relationship information is stored in a database (DB) according to an embodiment of the disclosure;

FIG. 4 is a diagram illustrating a screen that shows an electronic device processing a received voice input through an intelligent app according to an embodiment of the disclosure;

FIG. 5 is a schematic block diagram illustrating an electronic device according to an embodiment of the disclosure;

FIG. 6 is an example of a schematic block diagram illustrating a processor according to an embodiment of the disclosure;

FIG. 7 is another example of a schematic block diagram illustrating a processor according to an embodiment of the disclosure;

FIG. 8 is an example of an audio signal and a sensor signal according to an embodiment of the disclosure;

FIG. 9 is a diagram illustrating an example speaker verification operation according to an embodiment of the disclosure;

FIG. 10 is a diagram illustrating a signal restoration processing operation according to an embodiment of the disclosure;

FIGS. 11A, 11B, and 11C are diagrams illustrating other example speaker verification operations according to various embodiments of the disclosure;

FIG. 12 is a diagram illustrating an example user interface (UI) for speaker verification according to an embodiment of the disclosure; and

FIG. 13 is a flowchart illustrating an operation of an electronic device according to an embodiment of the disclosure.

The same reference numerals are used to represent the same elements throughout the drawings

### DETAILED DESCRIPTION

Hereinafter, various example embodiments will be described in greater detail with reference to the accompanying drawings. When describing the example embodiments with reference to the accompanying drawings, like reference numerals refer to like elements and any repeated description related thereto will be omitted.

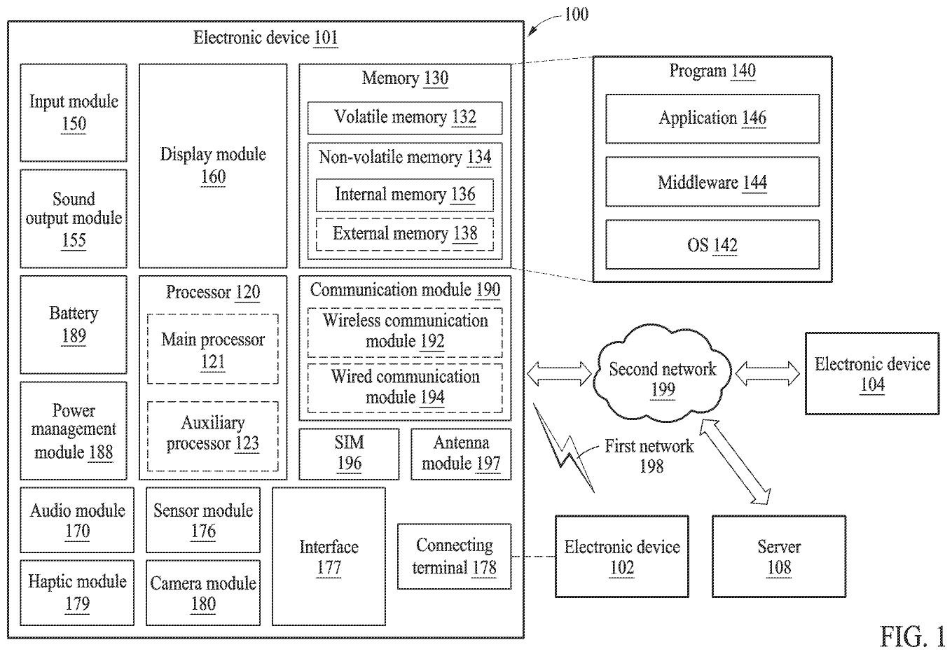

FIG. 1 is a block diagram illustrating an electronic device 101 in a network environment 100 according to various example embodiments.

Referring to FIG. 1, the electronic device 101 in the network environment 100 may communicate with an electronic device 102 via a first network 198 (e.g., a short-range wireless communication network), or communicate with at least one of an electronic device 104 or a server 108 via a second network 199 (e.g., a long-range wireless communication network). According to an example embodiment, the electronic device 101 may communicate with the electronic device 104 via the server 108. According to an example embodiment, the electronic device 101 may include any one or any combination of a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, and an antenna module 197. In some example embodiments, at least one (e.g., the connecting terminal 178) of the above components may be omitted from the electronic device 101, or one or more other components may be added in the electronic device 101. In some example embodiments, some (e.g., the sensor module 176, the camera module 180, or the antenna module 197) of the components may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to an example embodiment, as at least a part of data processing or computation, the processor 120 may store a command or data received from another components (e.g., the sensor module 176 or the communication module 190) in a volatile memory 132, process the command or the data stored in the volatile memory 132, and store resulting data in a non-volatile memory 134. According to an example embodiment, the processor 120 may include a main processor 121 (e.g., a central processing unit (CPU) or an application processor (AP)) or an auxiliary processor 123 (e.g., a graphics processing unit (GPU), a neural processing unit (NPU), an image signal processor (ISP), a sensor hub processor, or a communication processor (CP)) that is operable independently of, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an example embodiment, the auxiliary processor 123 (e.g., an ISP or a CP) may be implemented as a portion of another component (e.g., the camera module 180 or the communication module 190) that is functionally related to the auxiliary processor 123. According to an example embodiment, the auxiliary processor 123 (e.g., an NPU) may include a hardware structure specified for artificial intelligence model processing. An artificial intelligence model may be generated by machine learning. Such learning may be performed by, for example, the electronic device 101 in which artificial intelligence is performed, or performed via a separate server (e.g., the server 108). Learning algorithms may include, but are not limited to, for example, supervised learning, unsupervised learning, semi-supervised learning, or reinforcement learning. The artificial intelligence model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The artificial intelligence model may additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored as software in the memory 130, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing record. The receiver may be used to receive an incoming call. According to an example embodiment, the receiver may be implemented separately from the speaker or as a part of the speaker.

The display module 160 may visually provide information to the outside (e.g., a user) of the electronic device 101 (e.g., a user). The display module 160 may include, for example, a control circuit for controlling a display, a hologram device, or a projector and control circuitry to control a corresponding one of the display, the hologram device, and the projector. According to an example embodiment, the display module 160 may include a touch sensor adapted to sense a touch, or a pressure sensor adapted to measure an intensity of a force incurred by the touch.

The audio module 170 may convert a sound into an electric signal or vice versa. According to an example embodiment, the audio module 170 may obtain the sound via the input module 150 or output the sound via the sound output module 155 or an external electronic device (e.g., an electronic device 102 such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101, and generate an electric signal or data value corresponding to the detected state. According to an example embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an example embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an example embodiment, the connecting terminal 178 may include, for example, an HDMI connector, a USB connector, an SD card connector, or an audio connector (e.g., a headphone connector).

The haptic module 179 may convert an electric signal into a mechanical stimulus (e.g., a vibration or a movement) or an electrical stimulus which may be recognized by a user via his or her tactile sensation or kinesthetic sensation. According to an example embodiment, the haptic module 179 may include, for example, a motor, a piezoelectric element, or an electric stimulator.

The camera module 180 may capture a still image and moving images. According to an example embodiment, the camera module 180 may include one or more lenses, image sensors, image signal processors, or flashes.

The power management module 188 may manage power supplied to the electronic device 101. According to an example embodiment, the power management module 188 may be implemented as, for example, at least a part of a power management integrated circuit (PMIC).

The battery 189 may supply power to at least one component of the electronic device 101. According to an example embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently of the processor 120 (e.g., an AP) and that support a direct (e.g., wired) communication or a wireless communication. According to an example embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., a LAN or a wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a fourth generation (4G) network, and a next-generation communication technology, e.g., a new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an example embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an example embodiment, the antenna module 197 may include a slit antenna, and/or an antenna including a radiating element including a conductive material or a conductive pattern formed in or on a substrate (e.g., a printed circuit board (PCB)). According to an example embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or the power may be transmitted or received between the communication module 190 and the external electronic device via the at least one selected antenna. According to an example embodiment, another component (e.g., a radio frequency integrated circuit (RFIC)) other than the radiating element may be additionally formed as a part of the antenna module 197.

According to various example embodiments, the antenna module 197 may form a mmWave antenna module. According to an example embodiment, the mmWave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an example embodiment, commands or data may be transmitted or received between the electronic device 101 and the external electronic device 104 via the server 108 coupled with the second network 199. Each of the external electronic devices 102 and 104 may be a device of the same type as or a different type from the electronic device 101. According to an example embodiment, all or some of operations to be executed by the electronic device 101 may be executed at one or more of the external electronic devices 102, 104, and 108. For example, if the electronic device 101 needs to perform a function or a service automatically, or in response to a request from a user or another device, the electronic device 101, instead of, or in addition to, executing the function or the service, may request one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an example embodiment, the external electronic device 104 may include an Internet-of-things (IoT) device. The server 108 may be an intelligent server using machine learning and/or a neural network. According to an example embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various example embodiments may be one of various types of electronic devices. The electronic device may include, for example, a portable communication device (e.g., a smartphone), a computer device, a portable multimedia device, a portable medical device, a camera, a wearable device, or a home appliance device. According to an embodiment of the disclosure, the electronic device is not limited to those described above.

It should be appreciated that various example embodiments of the disclosure and the terms used therein are not intended to limit the technological features set forth herein to particular example embodiments and include various changes, equivalents, or replacements for a corresponding example embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “A, B, or C,” each of which may include any one of the items listed together in the corresponding one of the phrases, or all possible combinations thereof. Terms such as “first”, “second”, or “first” or “second” may simply be used to distinguish the component from other components in question, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various example embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an example embodiment, the module may be implemented in a form of an application-specific integrated circuit (ASIC).

Various example embodiments as set forth herein may be implemented as software (e.g., the program 140) including one or more instructions that are stored in a storage medium (e.g., an internal memory 136 or an external memory 138) that is readable by a machine (e.g., the electronic device 101) For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Here, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an example embodiment, a method according to various example embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various example embodiments, each component (e.g., a module or a program) of the above-described components may include a single entity or multiple entities, and some of the multiple entities may be separately disposed in different components. According to various example embodiments, one or more of the above-described components may be omitted, or one or more other components may be added. Alternatively or additionally, a plurality of components (e.g., modules or programs) may be integrated into a single component. In such a case, according to various example embodiments, the integrated component may still perform one or more functions of each of the plurality of components in the same or similar manner as they are performed by a corresponding one of the plurality of components before the integration. According to various example embodiments, operations performed by the module, the program, or another component may be carried out sequentially, in parallel, repeatedly, or heuristically, or one or more of the operations may be executed in a different order or omitted, or one or more other operations may be added.

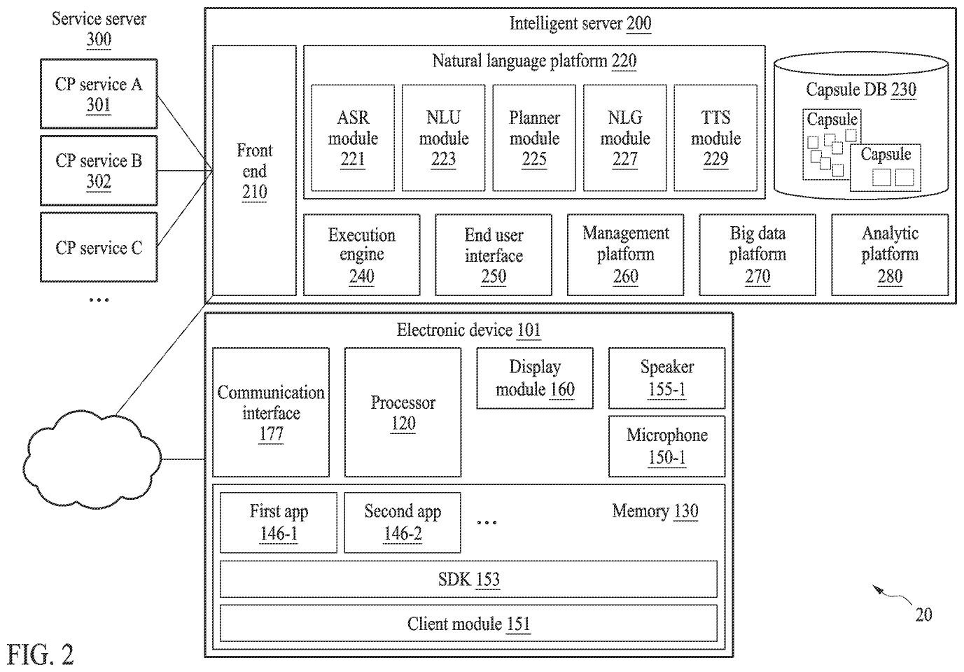

FIG. 2 is a block diagram illustrating an integrated intelligence system according to an embodiment of the disclosure.

Referring to FIG. 2, an integrated intelligence system 20 may include an electronic device (e.g., the electronic device 101 of FIG. 1), an intelligent server 200 (e.g., the server 108 of FIG. 1), and a service server 300 (e.g., the server 108 of FIG. 1).

The electronic device 101 may be a terminal device (or an electronic device) connectable to the Internet, and may be, for example, a mobile phone, a smartphone, a personal digital assistant (PDA), a laptop computer, a television (TV), a white home appliance, a wearable device, a head-mounted display (HMD), or a smart speaker.

As illustrated in FIG. 2, the electronic device 101 may include a communication interface 177 (e.g., the interface 177 of FIG. 1), a microphone 150-1 (e.g., the input module 150 of FIG. 1), a speaker 155-1 (e.g., the sound output module 155 of FIG. 1), a display module 160 (e.g., the display module 160 of FIG. 1), a memory 130 (e.g., the memory 130 of FIG. 1), and a processor 120 (e.g., the processor 120 of FIG. 1). The components listed above may be operationally or electrically connected to each other.

The communication interface 177 may be connected to an external device and configured to transmit and receive data to and from the external device. The microphone 150-1 may receive a sound (e.g., a user utterance) and convert the sound into an electrical signal. The speaker 155-1 may output the electrical signal as a sound (e.g., a voice or speech).

The display module 160 may be configured to display an image or video. The display module 160 may also display a graphic user interface (GUI) of an app (or an application program) being executed. The display module 160 may receive a touch input through a touch sensor. For example, the display module 160 may receive a text input through a touch sensor in an on-screen keyboard area displayed within the display module 160.

The memory 130 may store a client module 151, a software development kit (SDK) 153, and a plurality of apps 146 (e.g., the application 146 of FIG. 1). The client module 151 and the SDK 153 may configure a framework (or a solution program) for performing general-purpose functions. In addition, the client module 151 or the SDK 153 may configure a framework for processing a user input (e.g., a voice input, a text input, or a touch input).

The apps 146 may be programs for performing designated functions. The apps 146 may include a first app 146-1, a second app 146-2, and the like. Each of the apps 146 may include a plurality of actions for performing a designated function. For example, the apps 146 may include an alarm app, a message app, and/or a scheduling app. The apps 146 may be executed by the processor 120 to sequentially execute at least a portion of the actions.

The processor 120 may control the overall operation of the electronic device 101. For example, the processor 120 may be electrically connected to the communication interface 177, the microphone 150-1, the speaker 155-1, and the display module 160 to perform a designated operation.

The processor 120 may also perform the designated function by executing the program stored in the memory 130. For example, the processor 120 may execute at least one of the client module 151 or the SDK 153 to perform the following operations for processing a user input. The processor 120 may control the operations of the apps 146 through, for example, the SDK 153. The following operations described as operations of the client module 151 or the SDK 153 may be operations executed by the processor 120.

The client module 151 may receive a user input. For example, the client module 151 may receive a voice signal corresponding to a user utterance sensed through the microphone 150-1. In another example, the client module 151 may receive a touch input detected through the display module 160. In another example, the client module 151 may receive a text input detected through a keyboard or an on-screen keyboard. In addition, various forms of user inputs detected through an input module included or connected to the electronic device 101 may be received. The client module 151 may transmit the received user input to the intelligent server 200. The client module 151 may transmit state information of the electronic device 101 together with the received user input to the intelligent server 200. The state information may be, for example, execution state information of an app.

The client module 151 may receive a result corresponding to the received user input. For example, when the intelligent server 200 is capable of calculating a result corresponding to the received user input, the client module 151 may receive the result corresponding to the received user input. The client module 151 may display the received result on the display module 160. In addition, the client module 151 may output the received result as audio through the speaker 155-1.

The client module 151 may receive a plan corresponding to the received user input. The client module 151 may display, on the display module 160, results of executing a plurality of actions of an app according to the plan. The client module 151 may, for example, sequentially display the results of executing the actions on the display module 160 and output the results as audio through the speaker 155-1. As another example, the electronic device 101 may display only a partial result of executing the actions (e.g., a result of the last action) on the display module 160 and output the partial result as audio through the speaker 155-1.

The client module 151 may receive a request for obtaining information necessary for calculating a result corresponding to the user input from the intelligent server 200. The client module 151 may transmit the necessary information to the intelligent server 200 in response to the request.

The client module 151 may transmit information on the results of executing the actions according to the plan to the intelligent server 200. The intelligent server 200 may confirm that the received user input has been correctly processed using the information on the results.

The client module 151 may include a speech recognition module. The client module 151 may recognize a voice input for performing a limited function through the speech recognition module. For example, the client module 151 may execute an intelligent app for processing a voice input to perform an organic action through a designated input (e.g., Wake up!).

The intelligent server 200 may receive information related to a user voice input from the electronic device 101 through a communication network. The intelligent server 200 may change data related to the received voice input into text data. The intelligent server 200 may generate a plan for performing a task corresponding to the user voice input based on the text data.

The plan may be generated by an artificial intelligence (AI) system. The artificial intelligence system may be a rule-based system or a neural network-based system (e.g., a feedforward neural network (FNN) or an RNN). Alternatively, the artificial intelligence system may be a combination thereof or other artificial intelligence systems. The plan may be selected from a set of predefined plans or may be generated in real time in response to a user request. For example, the artificial intelligence system may select at least one plan from among the predefined plans.

The intelligent server 200 may transmit a result according to the generated plan to the electronic device 101 or transmit the generated plan to the electronic device 101. The electronic device 101 may display the result according to the plan on a display. The electronic device 101 may display a result of executing an action according to the plan on a display.

The intelligent server 200 may include a front end 210, a natural language platform 220, a capsule DB 230, an execution engine 240, an end user interface 250, a management platform 260, a big data platform 270, and an analytic platform 280.

The front end 210 may receive a user input from the electronic device 101. The front end 210 may transmit a response corresponding to the user input.

The natural language platform 220 may include an automatic speech recognition module (ASR) module 221, a natural language understanding (NLU) module 223, a planner module 225, a natural language generator (NLG) module 227, or a text-to-speech (TTS) module 229.

The ASR module 221 may convert the voice input received from the electronic device 101 into text data. The NLU module 223 may discern an intent of a user using the text data of the voice input. For example, the NLU module 223 may discern the intent of the user by performing a syntactic analysis or semantic analysis of the user input in the form of text data.

The NLU module 223 may discern the meaning of a word extracted from the user input using a linguistic feature (e.g., a grammatical element) of a morpheme or phrase, and determine the intent of the user by matching the discerned meaning of the word to the intent.

The planner module 225 may generate a plan using a parameter and the intent determined by the NLU module 223. The planner module 225 may determine a plurality of domains required to perform a task based on the determined intent. The planner module 225 may determine a plurality of actions included in each of the domains determined based on the intent. The planner module 225 may determine a parameter required to execute the determined actions or a result value output by the execution of the actions. The parameter and the result value may be defined as a concept of a designated form (or class). Accordingly, the plan may include a plurality of actions and a plurality of concepts determined by the intent of the user. The planner module 225 may determine a relationship between the actions and the concepts stepwise (or hierarchically). For example, the planner module 225 may determine an execution order of the actions determined based on the intent of the user, based on the concepts. In other words, the planner module 225 may determine the execution order of the actions based on the parameter required for the execution of the actions and results output by the execution of the actions. Accordingly, the planner module 225 may generate the plan including connection information (e.g., ontology) between the actions and the concepts. The planner module 225 may generate the plan using information stored in the capsule DB 230 that stores a set of relationships between concepts and actions.

The NLG module 227 may change designated information into a text form. The information changed to the text form may be in the form of a natural language utterance. The TTS module 229 may change information in a text form into information in a speech form.

According to an embodiment of the disclosure, some or all of the functions of the natural language platform 220 may also be implemented in the electronic device 101.

The capsule DB 230 may store information on relationships between a plurality of concepts and a plurality of actions corresponding to a plurality of domains. According to an embodiment of the disclosure, a capsule may include a plurality of action objects (or action information) and concept objects (or concept information) included in a plan. The capsule DB 230 may store a plurality of capsules in the form of a concept action network (CAN). According to an example embodiment, the capsules may be stored in a function registry included in the capsule DB 230.

The capsule DB 230 may include a strategy registry that stores strategy information necessary for determining a plan corresponding to a voice input. The strategy information may include reference information for determining one plan when there are a plurality of plans corresponding to the user input. The capsule DB 230 may include a follow-up registry that stores information on follow-up actions for suggesting a follow-up action to the user in a designated situation. The follow-up action may include, for example, a follow-up utterance. The capsule DB 230 may include a layout registry that stores layout information of information output through the electronic device 101. The capsule DB 230 may include a vocabulary registry that stores vocabulary information included in capsule information. The capsule DB 230 may include a dialog registry that stores information on a dialog (or an interaction) with the user. The capsule DB 230 may update the stored objects through a developer tool. The developer tool may include, for example, a function editor for updating an action object or a concept object. The developer tool may include a vocabulary editor for updating the vocabulary. The developer tool may include a strategy editor for generating and registering a strategy for determining a plan. The developer tool may include a dialog editor for generating a dialog with the user. The developer tool may include a follow-up editor for activating a follow-up objective and editing a follow-up utterance that provides a hint. The follow-up objective may be determined based on a currently set objective, a preference of the user, or an environmental condition. The capsule DB 230 may also be implemented in the electronic device 101.

The execution engine 240 may calculate a result using a generated plan. The end user interface 250 may transmit the calculated result to the electronic device 101. Accordingly, the electronic device 101 may receive the result and provide the received result to the user. The management platform 260 may manage information used by the intelligent server 200. The big data platform 270 may collect data of the user. The analytic platform 280 may manage a quality of service (QoS) of the intelligent server 200. For example, the analytic platform 280 may manage the components and processing rate (or efficiency) of the intelligent server 200.

The service server 300 may provide a designated service (e.g., food order or hotel reservation) to the electronic device 101. According to an embodiment of the disclosure, the service server 300 may be a server operated by a third party. The service server 300 may provide the intelligent server 200 with information to be used for generating a plan corresponding to a received user input. The provided information may be stored in the capsule DB 230. In addition, the service server 300 may provide result information according to the plan to the intelligent server 200. The service server 300 may provide the information and services via CP service A 301 and CP service B 302.

In the integrated intelligence system 20 described above, the electronic device 101 may provide various intelligent services to a user in response to a user input. The user input may include, for example, an input through a physical button, a touch input, or a voice input.

The electronic device 101 may provide a speech recognition service through an intelligent app (or a speech recognition app) stored therein. For example, the electronic device 101 may recognize a user utterance or a voice input received through the microphone, and provide a service corresponding to the recognized voice input to the user.

The electronic device 101 may perform a designated action alone or together with the intelligent server and/or the service server, based on a received voice input. For example, the electronic device 101 may execute an app corresponding to the received voice input and perform a designated action through the executed app.

When the electronic device 101 provides a service together with the intelligent server 200 and/or the service server, the electronic device 101 may detect a user utterance using the microphone 150-1 and generate a signal (or voice data) corresponding to the detected user utterance. The electronic device 101 may transmit the voice data to the intelligent server 200 using the communication interface 177.

The intelligent server 200 may generate, as a response to a voice input received from the electronic device 101, a plan for performing a task corresponding to the voice input or a result of performing an action according to the plan. The plan may include, for example, a plurality of actions for performing a task corresponding to a voice input of a user, and a plurality of concepts related to the actions. The concepts may define parameters input that are necessary to the execution of the actions or result values output by the execution of the actions. The plan may include information on relationships between the actions and the concepts.

The electronic device 101 may receive the response using the communication interface 177. The electronic device 101 may output a speech signal generated in the electronic device 101 to the outside using the speaker 155-1, or output an image generated in the electronic device 101 to the outside using the display module 160.

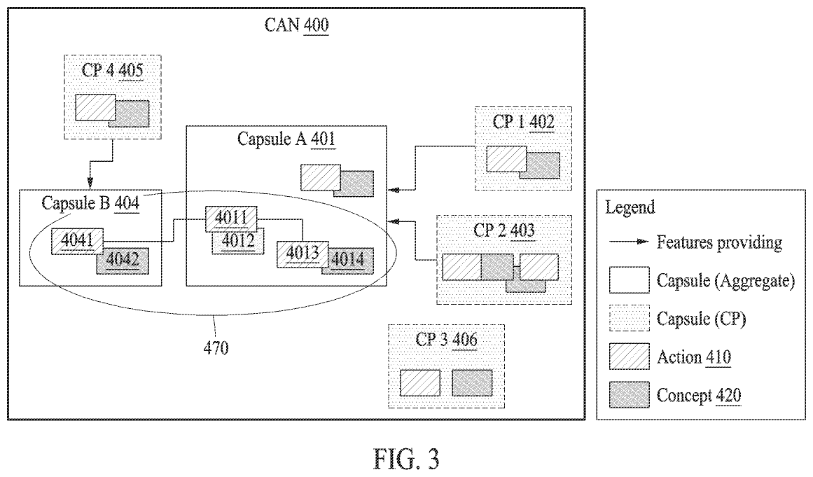

FIG. 3 is a diagram illustrating a form in which concept and action relationship information is stored in a DB according to embodiment of the disclosure.

Referring to FIG. 3, a capsule DB (e.g., the capsule DB 230) of the intelligent server 200 may store therein a capsule in the form of a CAN 400. The capsule DB may store, in the form of the CAN 400, actions for processing a task corresponding to a voice input of a user and parameters necessary for the actions.

The capsule DB may store a plurality of capsules, for example, referring to FIG. 3, a capsule A 401, a capsule B 404, and a capsule C 405, respectively corresponding to a plurality of domains (e.g., applications). One capsule (e.g., the capsule A 401) may correspond to one domain (e.g., a location (geo) or an application). In addition, one capsule may correspond to at least one service provider (e.g., CP1 402, CP2 403, or CP3 406) for performing a function for a domain related to the capsule. One capsule may include at least one action 410 for performing a designated function and at least one concept 420.

The natural language platform 220 may generate a plan for performing a task corresponding to a received voice input using the capsule stored in the capsule DB. For example, the planner module 225 of the natural language platform may generate the plan using the capsule stored in the capsule DB. For example, the planner module 225 may generate a plan 470 using actions 4011 and 4013 and concepts 4012 and 4014 of the capsule A 401 and using an action 4041 and a concept 4042 of the capsule B 404.

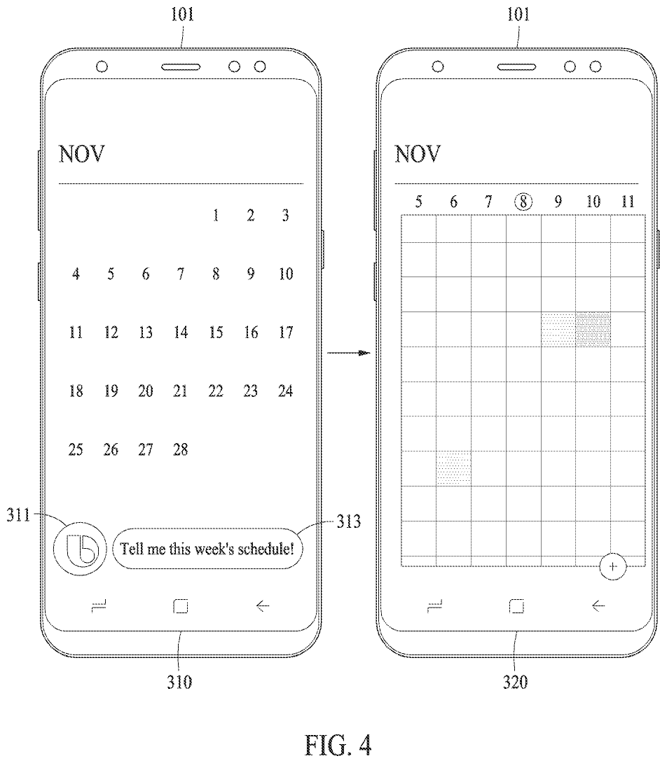

FIG. 4 is a diagram illustrating a screen that shows an electronic device processing a received voice input through an intelligent app according to an embodiment of the disclosure.

Referring to FIG. 4, an electronic device (e.g., the electronic device 101 of FIG. 1) may execute an intelligent app to process a user input through an intelligent server (e.g., the intelligent server 200 of FIG. 2).

According to an embodiment of the disclosure, on a screen 310, when a designated voice input (e.g., Wake up!) is recognized or an input through a hardware key (e.g., a dedicated hardware key) is received, the electronic device 101 may execute an intelligent app for processing the voice input. The electronic device 101 may execute the intelligent app, for example, while a scheduling app is being executed. The electronic device 101 may display an object (e.g., an icon) 311 corresponding to the intelligent app on the display module 160. According to an example embodiment, the electronic device 101 may receive a voice input by a user utterance. For example, the electronic device 101 may receive a voice input “Tell me this week's schedule!” The electronic device 101 may display a UI 313 (e.g., an input window) of the intelligent app in which text data of the received voice input is displayed.

According to an embodiment of the disclosure, on a screen 320, the electronic device 101 may display a result corresponding to the received voice input on the display module 160. For example, the electronic device 101 may receive the plan corresponding to the received user input, and display “the schedules this week” according to the plan on the display module 160.

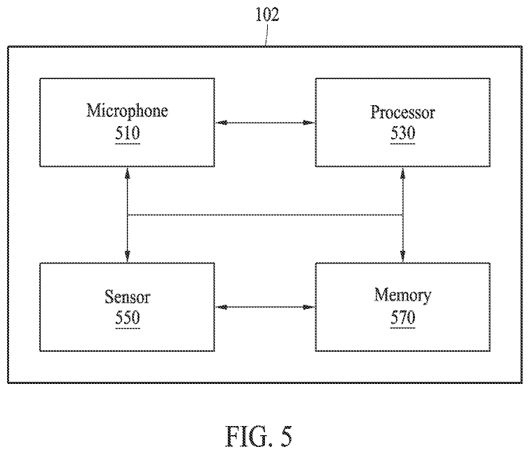

FIG. 5 is a schematic block diagram illustrating an electronic device according to an embodiment of the disclosure.

Referring to FIG. 5, an electronic device (e.g., the electronic device 101 of FIG. 1) may exchange data with an electronic device (e.g., the electronic device 102 of FIG. 2). The electronic device 102 may transmit authentication data related to a user to the electronic device 101. The electronic device 101 may release a lock of the electronic device 101 based on the received authentication data.

According to an embodiment of the disclosure, the electronic device 102 may include a wearable device. A wearable device may include electronic devices that a user may wear, such as a headphone, an earphone, a smartwatch, and/or smart glasses. The electronic device 102 may include a microphone 510, a processor 530, a sensor 550, and/or a memory 570. The microphone 510 may operate in the same manner as the microphone 150-1 of FIG. 2. The microphone 510 may receive an audio signal including a voice of a user. The microphone 510 may output the received audio signal to the processor 530.

The sensor 550 may detect a vibration signal generated by a user. The sensor 550 may output the detected vibration signal to the processor 530. The sensor 550 may include at least one sensor. The sensor 550 may detect biometric information and/or a motion of a wearer of the electronic device 102. For example, the sensor 550 may include a proximity sensor for detecting a wearing state, a biometric sensor (e.g., a heart rate sensor) for detecting biometric information, and/or a motion sensor (e.g., an acceleration sensor) for detecting a motion.

The sensor 550 may further include at least one of a vibration pickup unit (VPU), a bone conduction sensor, or an acceleration sensor. The acceleration sensor may be disposed close to the skin to detect bone conduction. For example, the acceleration sensor may be adapted to detect tremble information in kHz units using sampling in units of kHz, which is relatively higher than general motion sampling. The processor 530 may perform voice identification, voice detection, tap detection, and/or wear detection in a noisy environment based on a tremble centered on a significant axis (one of x, y, and z axes) among the tremble information of the acceleration sensor.

The memory 570 may operate in the same manner as the memory 130 of FIG. 1.

The processor 530 may operate in the same manner as the processor 120 of FIG. 1. The processor 530 may determine a noise level included in an audio signal. The processor 530 may determine the noise level by comparing a power of noise included in the audio signal and a predetermined noise threshold.

The processor 530 may calculate a verification score based on a noise level, an audio signal, and a vibration signal. The processor 530 may calculate a first verification score included in the verification score based on the audio signal. The processor 530 may extract an audio feature from the audio signal and calculate the first verification score based on the audio feature.

The processor 530 may calculate a second verification score included in the verification score based on a vibration signal. The processor 530 may extract a vibration feature from the vibration signal and calculate the second verification score based on the vibration feature.

The processor 530 may restore a vibration signal. The processor 530 may filter the vibration signal, restore a high-frequency component of a filtered vibration signal, and remove noise from the filtered vibration signal.

The processor 530 may perform speaker verification for a user based on the verification score. The processor 530 may determine a first weight corresponding to the first verification score. The processor 530 may determine a second weight corresponding to the second verification score.

The processor 530 may perform speaker verification for a user based on the first verification score, the first weight, the second verification score, and the second weight. The processor 530 may determine the first weight and the second weight based on a neural network trained based on the noise level and a type of noise. The processor 530 may determine whether the user is wearing the electronic device 102 and determine the first weight and the second weight based on a result of the determination.

When the electronic device 102 is newly registered with the electronic device 101, the processor 530 may register a voice of a user using the electronic device 102 when a voice unlock state is enabled. The processor 530 may collect signals of the microphone 510 and the sensor 550 to generate a speaker verification model corresponding to each signal.

A speaker verification model may be generated using only a microphone signal included in the electronic device 101. When the user is wearing the electronic device 102, the processor 530 may generate one or more speaker verification model using an audio signal input to the microphone 510 and a vibration signal input to the sensor 550. In this case, a maximum of three speaker verification models may exist in the electronic device 101. The three speaker verification models may include a speaker verification model generated based on a microphone signal included in the electronic device 101, a speaker verification model generated based on an audio signal included in the microphone 510, and a speaker verification model generated based on a vibration signal of the sensor 550.

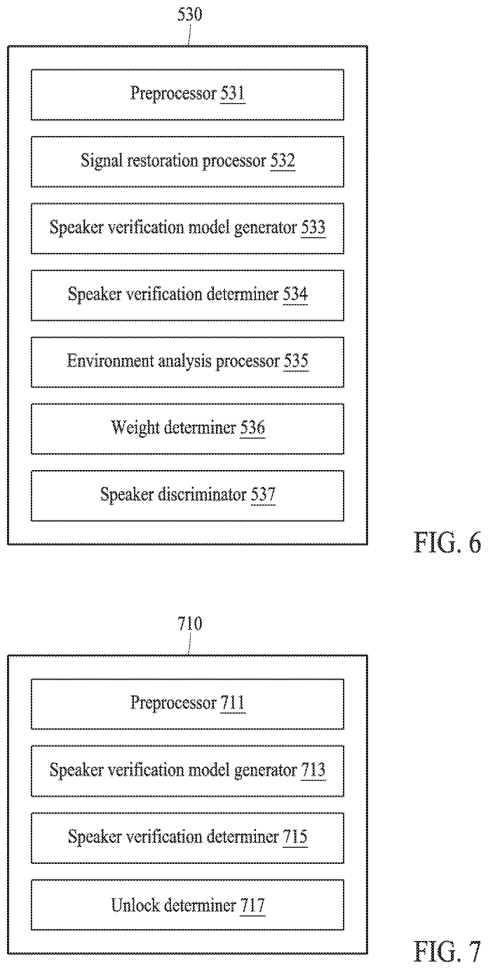

FIG. 6 is an example of a schematic block diagram illustrating a processor according to an embodiment of the disclosure.

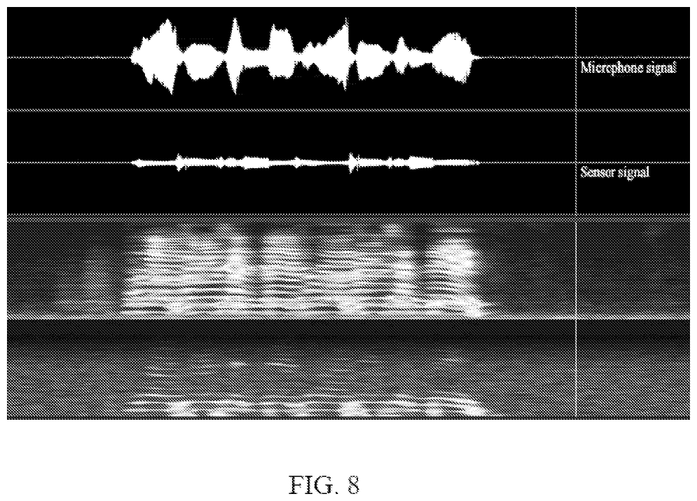

FIG. 7 is another example of a schematic block diagram illustrating a processor according to embodiment of the disclosure.

Referring to FIGS. 6 and 7, the processor 530 may include a preprocessor 531, a signal restoration processor 532, a speaker verification model generator 533, a speaker verification determiner 534, an environment analysis processor 535, a weight determiner 536, and a speaker discriminator 537.

The preprocessor 531 may perform preprocessing for an audio signal and/or a vibration signal. The signal restoration processor 532 may restore a vibration signal to a signal similar to an audio signal. The signal restoration processor 532 may filter the vibration signal, restore a high-frequency component of a filtered vibration signal, and remove noise from the filtered vibration signal.

The speaker verification model generator 533 may generate a speaker verification model based on an audio signal and/or a vibration signal. The speaker verification determiner 534 may determine whether a speaker is verified based on an output of the speaker verification model. The environment analysis processor 535 may analyze the state of a surrounding environment based on an input of a microphone (e.g., the microphone 510 of FIG. 5) and a sensor (e.g., the sensor 550 of FIG. 5). The environment analysis processor 535 may analyze a type of noise and noise level in a surrounding environment based on a signal input to the microphone 510 and the sensor 550.

The environment analysis processor 535 may determine a noise level using an audio signal received by a microphone (e.g., the microphone 510 of FIG. 5) and a vibration signal received by a sensor (e.g., the sensor 550 of FIG. 5).

The environment analysis processor 535 may determine the noise level based on a power level of an audio signal received by the microphone 510. The environment analysis processor 535 may verify noise including stationary noise that is received constantly or wind noise that generates very strong signals.

The environment analysis processor 535 may determine the noise level using a spectral noise estimation scheme or a time domain power minimum tracking scheme. The spectral noise estimation scheme may include a series of operations to determine the noise level using smoothing, an overall average power of frequency per frame, or an average power during a preset time (e.g., seconds).

The time domain power minimum tracking scheme may include an operation to determine the noise level based on a first threshold and a second threshold. For example, when using the time domain power minimum tracking scheme, the processor 530 may determine that the environment is a noise-free environment when a noise power is less than or equal to a first threshold, determine that the environment is a low-noise level environment when the noise power is greater than the first threshold and less than or equal to the second threshold, and determine that the environment is a high-noise level environment when the noise power is greater than the second threshold.

The environment analysis processor 535 may determine a type of noise by analyzing a frequency feature of an audio signal to determine a noise environment. For example, the environment analysis processor 535 may determine environments such as the inside of a vehicle, a café, a supermarket, or a street.

The environment analysis processor 535 may determine whether a user is wearing an electronic device (e.g., the electronic device 102 of FIG. 5). The environment analysis processor 535 may determine whether the user is wearing the electronic device 102 by calculating a non-wearer speech score. When a voice of a person other than the user is input, the environment analysis processor 535 may calculate the non-wearer speech score based on a signal input to the microphone 510 and the sensor 550 to determine when an utterance of the other person is continuing

When calculating a noise level, real-time power and an average noise level during a few seconds prior to a current point in time may be used, and when determining a type of noise, a general learning scheme may be used. Output of the environment analysis processor 535 such as the noise level, type of noise, and non-wearer speech score may be used for operations of determining a verification score transmitted from each speaker verification model based on environment analysis information, determining a weight, and performing speaker verification based on a threshold.

The weight determiner 536 may determine a weight corresponding to a speaker verification score transmitted from a speaker verification model based on an analysis result of the environment analysis processor 535. The speaker discriminator 537 may ultimately determine a speaker based on a weight and a threshold.

According to an embodiment of the disclosure, a processor 710 may be implemented within an electronic device (e.g., the electronic device 101 of FIG. 1). The processor 710 may include a preprocessor 711, a speaker verification model generator 713, a speaker verification determiner 715, and an unlock determiner 717.

The preprocessor 711 may perform preprocessing for an audio signal. The speaker verification model generator 713 may generate a speaker verification model based on an audio signal. The speaker verification determiner 715 may determine whether a speaker is verified based on an output of the speaker verification model. The unlock determiner 717 may determine whether an electronic device (e.g., the electronic device 101 of FIG. 1) is in a lock or an unlock state based on a speaker verification result.

FIG. 8 is an example of an audio signal and a sensor signal according to an embodiment of the disclosure.

Referring to FIG. 8, a microphone (e.g., the microphone 510 of FIG. 5) may receive an audio signal. A sensor (e.g., the sensor 550 of FIG. 5) may receive a vibration signal.

The sensor 550 may be used in a supplementary manner to resolve an issue of a voice of a user not being recognized due to sound coming from an external speaker.

Since a signal (e.g., a vibration signal) detected from the sensor 550 is input in a form with a frequency band limitation, it may be difficult to generate a model for speaker recognition if the signal is used in a form such as a general microphone input without processing. The microphone 510 may be a main microphone among a plurality of microphones included in a wearable device. According to an embodiment of the disclosure, the microphone 510 may be an external sub microphone or an internal microphone of a wearable device.

When the electronic device 101 connected to the electronic device 102 is used, a processor (e.g., the processor 530 of FIG. 5) may improve speaker verification performance by restoring a vibration signal of the sensor 550 to provide a vibration signal having a similar level of sound quality and bandwidth to a voice signal received by the microphone 510 through a preprocessing operation.

The processor 530 may perform signal enhancement processing of a vibration signal of the electronic device 102 through a signal restoration model to provide a vibration signal having a similar level of sound quality and bandwidth to a voice signal received by the microphone 510.

The processor 530 may determine whether it is a difficult environment (e.g., a high-noise environment) for speaker verification using only a microphone (e.g., the microphone 151-1 of FIG. 2) built into the electronic device 101 and the microphone 510 built into the electronic device 102. Based on a result of the determination, in the case of a low-noise environment, the processor 530 may perform speaker verification using only the microphone 510, and in the case of a high-noise environment, the processor 530 may perform speaker verification by comprehensively considering a vibration signal of the sensor 550, thereby improving speaker verification performance.

The processor 530 may determine whether there are many utterances around a user wearing the electronic device 102 or whether a size of a noise is great and analyze background noise to extract a noise level and a type of noise. The processor 530 may distinguish a speaker by using a speaker verification model at a minimum based on the noise level and the type of noise, and may reduce latency that occurs when speaker authentication is performed.

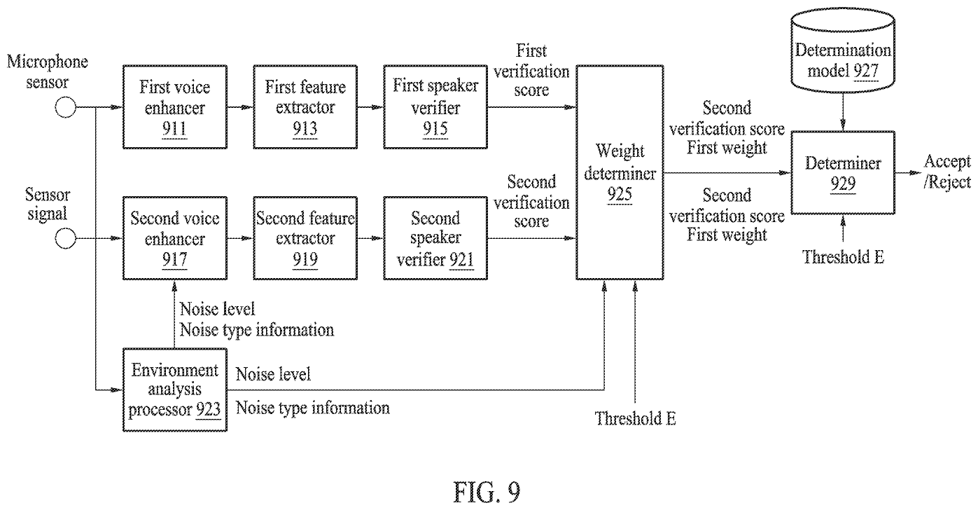

FIG. 9 is a diagram illustrating an example speaker verification operation according to an embodiment of the disclosure.

Referring to FIG. 9, a processor (e.g., the processor 530 of FIG. 5) may generate a speaker verification model corresponding to a microphone (e.g., the microphone 510 of FIG. 5) and a speaker verification model corresponding to a sensor (e.g., the sensor 550 of FIG. 5), and may improve speaker verification performance in poor external environments using the generated speaker verification models.

The processor 530 may determine a noise level, and in the case of a low-noise environment, perform speaker verification using only the microphone 510, and in the case of a high-noise environment, perform speaker verification using the microphone 510 and the sensor 550 substantially at the same time. The processor 530 may determine whether the environment is a low-noise, or a high-noise environment based on the noise level, a type of noise, and a non-wearer speech score.

The processor 530 may include a first voice enhancer 911, a first feature extractor 913, a first speaker verifier 915, a second voice enhancer 917, a second feature extractor 919, a second speaker verifier 921, an environment analysis processor 923, a weight determiner 925, and a determiner 929.

The first voice enhancer 911 may perform preprocessing of an audio signal received from the microphone 510. The first voice enhancer 911 may remove noise from an audio signal. For example, the first voice enhancer 911 may remove background noise from the audio signal.

The first feature extractor 913 may extract a feature from an output of the first voice enhancer 911. The first speaker verifier 915 may calculate a first verification score based on an output of the first feature extractor 913.

The second voice enhancer 917 may perform preprocessing of a vibration signal received from the sensor 550. The second voice enhancer 917 may perform restoration processing of the vibration signal. The second voice enhancer 917 may perform high-pass filtering to adjust a DC offset of the vibration signal, and perform preprocessing to restore a bandlimited vibration signal to a level of an audio signal of the microphone 510. The second voice enhancer 917 may perform gain control for audio level matching of an audio signal and a vibration signal.

The second feature extractor 919 may extract a feature from an output of the second voice enhancer 917. The second speaker verifier 921 may calculate a second verification score based on an output of the second feature extractor 919.

The weight determiner 925 may determine a weight based on the first verification score and the second verification score. The weight determiner 925 may determine a first weight corresponding to the first verification score and determine a second weight corresponding to the second verification score.

The weight determiner 925 may determine a first weight to be applied to the first verification score obtained based on an audio signal of the microphone 510 and a second weight to be applied to the second verification score obtained based on a vibration signal of the sensor 550.

The weight determiner 925 may determine a first weight and a second weight based on the non-wearer speech score, the noise level, and the type of noise. The weight determiner 925 may generate a table according to the noise level and the type of noise, and determine the first weight and the second weight based on the generated table. Table 1 may represent an example of a table of the first weight and the second weight.

TABLE 1

| Noise | Type of | Non-wearer | First | Second |
|---|---|---|---|---|
| level | noise | speech score | weight | weight |
| 20 | Cafe | 0 | 1 | 0 |
| 20 | Cafe | 1 | 0 | 1 |
| 90 | Cafe | 1 | 0 | 1 |

The weight determiner 925 may determine the first weight and the second weight using a neural network trained based on the non-wearer speech score, the noise level, and the type of noise.

The neural network may be an overall model that has problem-solving ability in which artificial neurons (nodes) form a network by combining synapses and change the strength of synaptic bonding through learning.

A neuron of the neural network may include a combination of weights or biases. The neural network may include one or more layer of one or more neuron or node. The neural network may infer a result to be predicted from an arbitrary input by changing a weight of a neuron through training.

The neural network may include a DNN. The neural network may include a CNN, an RNN, a perceptron, a multilayer perceptron, a feed forward (FF), a radial basis network (RBF), a deep feed forward (DFF), a long short term memory (LSTM), a gated recurrent unit (GRU), an auto encoder (AE), a variational auto encoder (VAE), a denoising auto encoder (DAE), a sparse auto encoder (SAE), a markov chain (MC), a hopfield network (HN), a boltzmann machine (BM), an RBM, a DBN, a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a kohonen network (KN), and an attention network (AN).

The determiner 929 may perform speaker verification for a user based on the first verification score, the first weight, the second verification score, and the second weight. The determiner 929 may determine whether to accept or reject a speaker using a determination model 927. The determiner 929 may determine whether to accept or reject based on a threshold E.

The determiner 929 may perform a determination to accept or reject based on the first verification score, the first weight, the second verification score, and the second weight. Based on a result of the determination to accept or reject, it may be determined whether the electronic device 101 is in a lock or an unlock state.

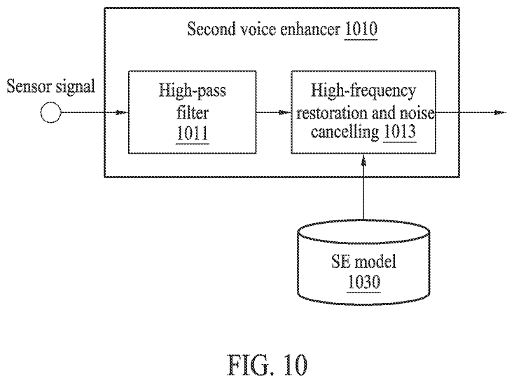

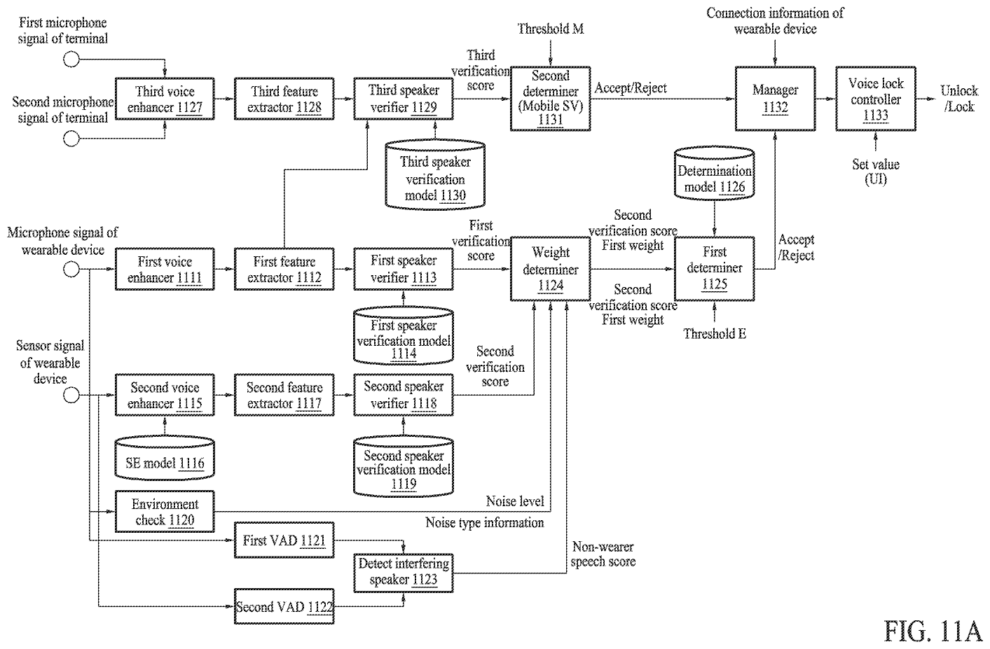

FIG. 10 is a diagram illustrating a signal restoration processing operation according to an embodiment of the disclosure.

Referring to FIG. 10, a second voice enhancer 1010 (e.g., the second voice enhancer 917 of FIG. 9) may perform preprocessing of a vibration signal received from a sensor (e.g., the sensor 550 of FIG. 5) to improve the vibration signal such that it has a similar level of sound quality and bandwidth to an audio signal received by a microphone (e.g., the microphone 510 of FIG. 5).

A vibration signal may include a VPU signal generated in a band of about 2 kHz or less. The vibration signal may have a lower resolution than a voice signal, and may include signal distortion due to various vibrations (e.g., masticatory movement, touching of the face, wind) occurring around the electronic device 102 in addition to vibration generated by an utterance. The second voice enhancer 1010 may perform signal restoration to restore the vibration signal to a level of an audio signal received from the microphone 510.

The second voice enhancer 1010 may generate a deep learning based signal restoration model (e.g., a universal model) using a large quantity of an audio signal received from the microphone 510 and a vibration signal recorded substantially at the same time as the audio signal. The second voice enhancer 1010 may appropriately adapt a pre-trained restoration model to a user using a signal that occurs when speaker registration is performed through the electronic device 102. For example, the second voice enhancer 1010 may perform a bandwidth extension (BWE) operation, a deep learning based noise cancelling operation, or a restoration signal generation operation through a GAN.

The second voice enhancer 1010 may perform filtering using a high-pass filter 1011. The second voice enhancer 1010 may perform high-frequency restoration and noise cancelling 1013 using a speech enhancement (SE) model 1030.

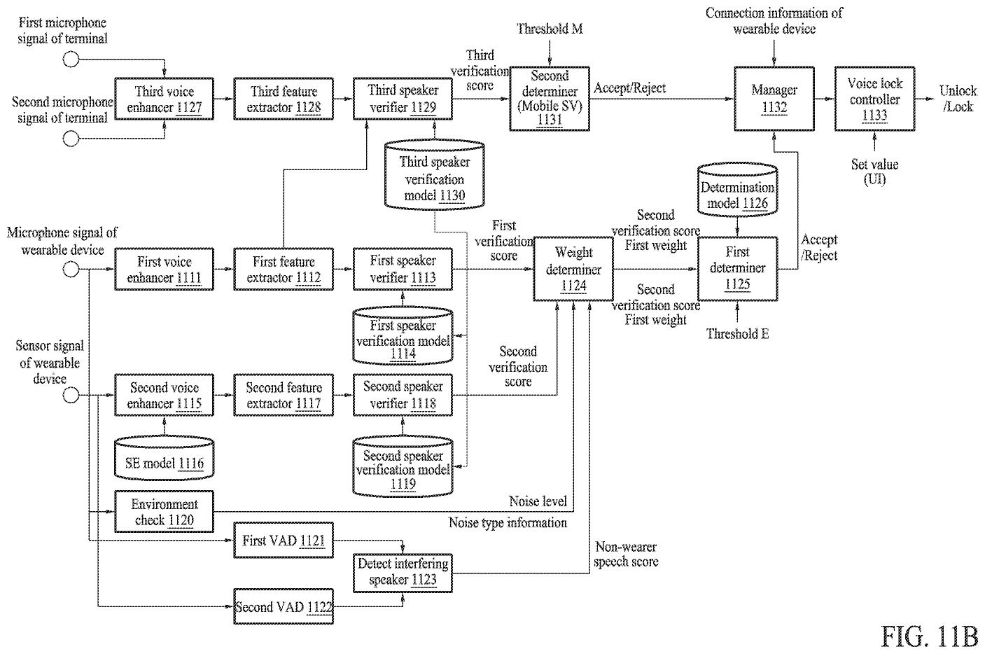

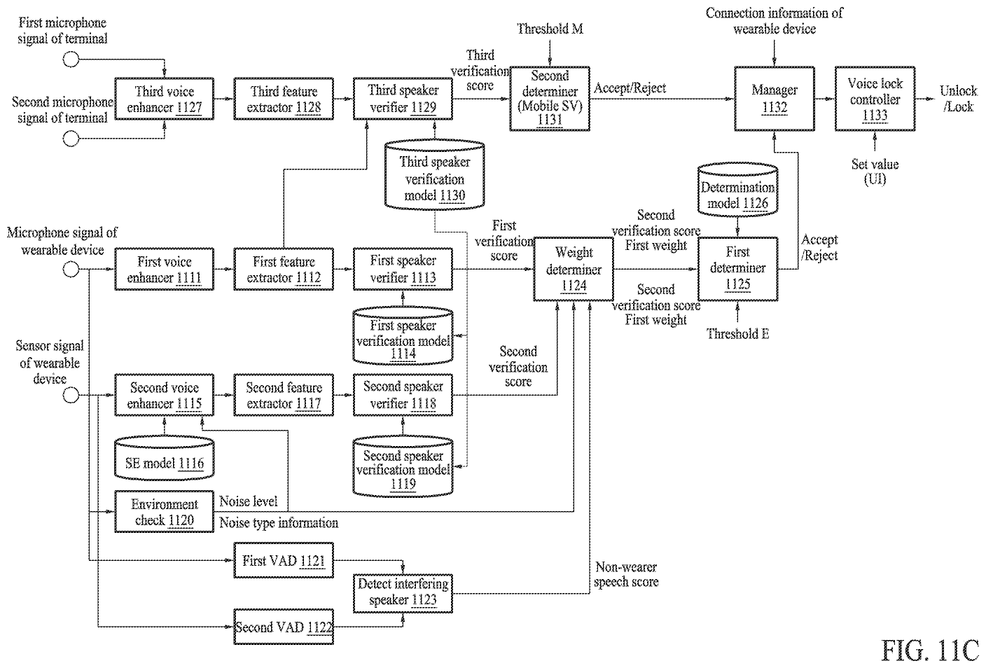

FIGS. 11A, 11B, and 11C are diagrams illustrating other example speaker verification operations according to various embodiments of the disclosure.

Referring to FIGS. 11A to 11C, a terminal (e.g., the electronic device 101 of FIG. 1) may perform speaker verification by communicating with a wearable device (e.g., the electronic device 102 of FIG. 5).

A processor (e.g., the processor 530 of FIG. 5) of the electronic device 102 may include a first voice enhancer 1111, a first feature extractor 1112, a first speaker verifier 1113, a second voice enhancer 1115, a second feature extractor 1117, a second speaker verifier 1118, an environment check module 1120, a weight determiner 1124, and a first determiner 1125. Operations of the first voice enhancer 1111, the first feature extractor 1112, the first speaker verifier 1113, the second voice enhancer 1115, the second feature extractor 1117, the second speaker verifier 1118, the environment check module 1120, the weight determiner 1124, and the first determiner 1125 may be identical to the operations of the first voice enhancer 911, the first feature extractor 913, the first speaker verifier 915, the second voice enhancer 917, the second feature extractor 919, the second speaker verifier 921, the environment analysis processor 923, the weight determiner 925, and the determiner 929, respectively. The environment check module 1120 may operate in the same manner as the environment analysis processor 923 of FIG. 9.

The first speaker verifier 1113 may calculate a first verification score using a first speaker verification model 1114. The second voice enhancer 1115 may perform restoration processing of a vibration signal using an SE model 1116. The second speaker verifier 1118 may calculate a second verification score using a second speaker verification model 1119. The first determiner 1125 may perform a determination to accept or reject a speaker using a determination model 1126.

A processor (e.g., the processor 120 of FIG. 1) of the electronic device 101 may include a third voice enhancer 1127, a third feature extractor 1128, a third speaker verifier 1129, and a second determiner 1131. The third voice enhancer 1127 may remove noise from a signal of a microphone built into the electronic device 101. The electronic device 101 may include multiple microphones (e.g., a first microphone and a second microphone). The third voice enhancer 1127 may process an audio signal based on a single microphone or multiple microphones and may output an audio signal in a bypass form without performing any processing.

The processor 120 may receive, from a wearable device (e.g., the electronic device 102 of FIG. 5), an indication whether to allow a first permission determined by the first verification score and the second verification score calculated based on an audio signal received through a microphone (e.g., the microphone 510 of FIG. 5) of the wearable device, a noise level included in the audio signal, and a vibration signal generated by a user.

The processor 120 may calculate a third verification score based on an audio signal received through a microphone (the first microphone or the second microphone), determine whether to allow a second permission based on the third verification score, and perform speaker verification based on the first permission and the second permission.

A noise level may be determined by comparing a power of noise included in an audio signal and a predetermined noise threshold. The first verification score may be calculated based on an audio signal and the second verification score may be calculated based on a vibration signal. Whether to allow a first permission may be determined based on a first weight corresponding to the first verification score, a second weight corresponding to the second verification score, and the first verification score and the second verification score.

The first weight and the second weight may be determined based on a neural network trained based on the noise level and a type of noise. The first weight and the second weight may be determined based on whether a user is wearing a wearable device. The first verification score may be calculated based on an audio feature extracted from an audio signal. The second verification score may be calculated based on a vibration feature extracted from a vibration signal. The second verification score may be calculated by filtering the vibration signal, restoring a high-frequency component of a filtered vibration signal, and removing noise from the filtered vibration signal.

The processor 120 may perform speaker verification based on whether a wearable device and the processor 120 are connected and based on the first permission and the second permission.

The third feature extractor 1128 may extract a feature from an output of the third voice enhancer 1127. The third speaker verifier 1129 may calculate the third verification score based on an output of the third feature extractor 1128 using a third speaker verification model 1130. The third speaker verifier 1129 may calculate the third verification score by considering an output of the first feature extractor 1112 along with the output of the third feature extractor 1128. As shown in FIGS. 11B and 11C, a parameter of the third speaker verification model 1130 may be shared with the first speaker verification model 1114 and the second speaker verification model 1119.

Speaker verification may be performed using a speaker verification model (e.g., the first speaker verification model 1114 and the second speaker verification model 1119) in the electronic device 102, or model adaptation may be performed by comprehensively considering a speaker verification model (e.g., the third speaker verification model 1130) of the electronic device 101. A speaker verification model generated by the electronic device 102 may replace a speaker verification model of the electronic device 101.

The second determiner 1131 may determine to accept or reject a speaker based on the third verification score.

A manager 1132 may be located inside the electronic device 101 or inside the electronic device 102. The manager 1132 may perform speaker verification based on whether an option is selected in a UI. The manager 1132 may control unlocking or locking of a voice lock controller 1133 based on an output of the first determiner 1125 and an output of the second determiner 1131, and connection information of a wearable device. The voice lock controller 1133 may perform unlocking or locking of the electronic device 101 based on a set value and an output of the manager 1132.

The voice lock controller 1133 may be implemented in the electronic device 101. When a user registers the electronic device 102 using the UI and selects the option of voice unlock, the processor 530 of the electronic device 102 may perform speaker verification using signals of the microphone 510 and the sensor 550.

When the electronic device 101 and the electronic device 102 are not connected, the manager 1132 may perform locking or unlocking based on a third verification score obtained by using only a microphone signal of the electronic device 101.

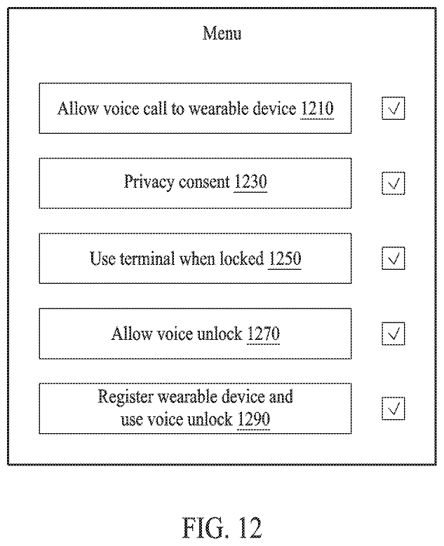

FIG. 12 is a diagram illustrating an example UI for speaker verification according to an embodiment of the disclosure.

Referring to FIG. 12, when it is detected that an electronic device (e.g., the electronic device 102 of FIG. 5) is being worn, a processor (e.g., the processor 530 of FIG. 5) may receive a signal of the microphone 510 and the sensor 550 as input to release a lock of another electronic device (e.g., the electronic device 101 of FIG. 1) communicating with the electronic device 102.

The processor 530 may release a lock (e.g., a screen lock) of the electronic device 101 or perform user verification required in various applications by performing speaker verification. For example, the processor 530 may perform verification used in a payment method.

The processor 530 may release a screen lock when it is necessary to release the screen lock by performing speaker verification. When releasing the screen lock is unnecessary and only feedback is needed, the processor 530 may provide only a performance result of a voice agent (or a voice assistant) by providing only text-to-speech (TTS) type feedback.

The processor 530 may provide a UI as shown in the example of FIG. 12. The UI may provide an option to allow a voice call to a wearable device 1210, a privacy consent option 1230, an option to use a locked terminal 1250, an option to allow voice unlock 1270, and an option to register a wearable device and use voice unlock 1290.

A user registration may be performed through a wearable device (e.g., the electronic device 102), and when the option to allow a voice call to a wearable device 1210 is off or when the option to allow voice unlock 1270 is off, speaker verification may be performed through a speaker verification model generated through the wearable device based on an audio signal received from the microphone 510.

The UI of FIG. 12 may be provided through a sub menu of a voice assistant application. When the option to allow voice unlock 1270 is selected, the processor 530 may link a screen lock or a face lock. The processor 530 may perform speaker verification only when the option to allow a voice call to a wearable device 1210 is selected.

When the option to register a wearable device and use voice unlock 1290 is selected, the processor 530 may perform user voice registration through a wearable device. The wearable device may collect an audio signal and a vibration signal through the microphone 510 and the sensor 550 to generate a speaker verification model, respectively. When the option to allow a voice call to a wearable device 1210 is off or when the option to register a wearable device and use voice unlock 1290 is off, speaker verification may be performed through a speaker verification model generated from the electronic device 101. In this case, an audio signal received from a microphone (e.g., the microphone 150-1 of FIG. 2) or the microphone 510 may be used in the speaker verification.

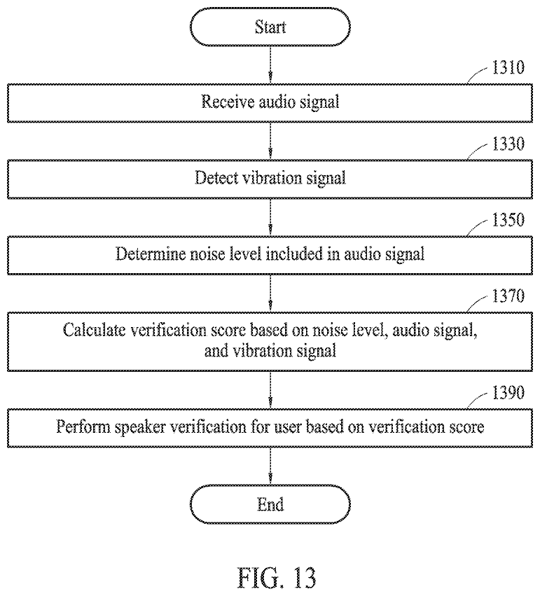

FIG. 13 is a flowchart illustrating an operation of an electronic device according to an embodiment of the disclosure.

Referring to FIG. 13, a microphone (e.g., the microphone 510 of FIG. 5) may receive an audio signal including a voice of a user at operation 1310. A sensor (e.g., the sensor 550 of FIG. 5) may detect a vibration signal generated by the user at operation 1330.

A processor (e.g., the processor 530 of FIG. 5) may determine a noise level included in an audio signal at operation 1350. The processor 530 may determine the noise level by comparing a power of noise included in the audio signal and a predetermined noise threshold.

The processor 530 may calculate a verification score based on a noise level, an audio signal, and a vibration signal at operation 1370. The processor 530 may calculate a first verification score included in the verification score based on the audio signal. The processor 530 may extract an audio feature from the audio signal and calculate the first verification score based on the audio feature.

The processor 530 may calculate a second verification score included in the verification score based on the vibration signal. The processor 530 may extract a vibration feature from the vibration signal and calculate the second verification score based on the vibration signal.

The processor 530 may restore a vibration signal. The processor 530 may filter the vibration signal, restore a high-frequency component of a filtered vibration signal, and remove noise from the filtered vibration signal.

The processor 530 may perform speaker verification for a user based on the verification score at operation 1390. The processor 530 may determine a first weight corresponding to the first verification score. The processor 530 may determine a second weight corresponding to the second verification score.

The processor 530 may perform speaker verification for the user based on the first verification score, the first weight, the second verification score, and the second weight. The processor 530 may determine the first weight and the second weight based on a neural network trained based on the noise level and a type of noise. The processor 530 may determine whether the user is wearing the electronic device 102 and determine the first weight and the second weight based on a result of the determination.

According to an embodiment of the disclosure, an electronic device (e.g., the electronic device 102 of FIG. 5) may include a microphone (e.g., the microphone 510 of FIG. 5) configured to receive an audio signal including a voice of a user, a sensor (e.g., the sensor 550 of FIG. 5) configured to detect a vibration signal generated by the user, one or more processor (e.g., the processor 530 of FIG. 5), and a memory (e.g., the memory 570 of FIG. 5) configured to store an instruction executable by the processor, wherein the processor 530 may be configured to determine a noise level included in the audio signal, calculate a verification score based on the noise level, the audio signal, and the vibration signal, and perform speaker verification for the user based on the verification score.

The processor 530 may determine the noise level by comparing a power of noise included in the audio signal and a predetermined noise threshold.

The processor 530 may calculate a first verification score included in the verification score based on the audio signal, and calculate a second verification score included in the verification score based on the vibration signal.

The processor 530 may determine a first weight corresponding to the first verification score, determine a second weight corresponding to the second verification score, and perform speaker verification for the user based on the first verification score, the first weight, the second verification score, and the second weight.

The processor 530 may determine the first weight and the second weight based on a neural network trained based on the noise level and a noise type.

The processor 530 may determine whether the user is wearing the electronic device and determine the first weight and the second weight based on a result of the determination.

The processor 530 may extract an audio feature from the audio signal and calculate the first verification score based on the audio feature.

The processor 530 may extract a vibration feature from the vibration signal and calculate the second verification score based on the vibration signal.

The processor 530 may filter the vibration signal, restore a high-frequency component of a filtered vibration signal, and remove noise from the filtered vibration signal.

The processor 530 may include a first microphone configured to receive an audio signal including a voice of a user, a processor, and a memory configured to store an instruction executable by the processor, wherein the processor may be configured to receive, from a wearable device, an indication whether to allow a first permission determined by a first verification score and a second verification score calculated based on an audio signal received through a second microphone of the wearable device, a noise level included in the audio signal, and a vibration signal generated by the user, determine whether to allow a second permission based on a third verification score, and perform speaker verification based on the first permission and the second permission.

The noise level may be determined by comparing a power of noise included in the audio signal and a predetermined noise threshold.

The first verification score may be calculated based on the audio signal and the second verification score may be calculated based on the vibration signal.

Whether to allow the first permission may be determined based on a first weight corresponding to the first verification score, a second weight corresponding to the second verification score, and the first verification score and the second verification score.

The first weight and the second weight may be determined based on a neural network trained based on the noise level and a type of noise.

The first weight and the second weight may be determined based on whether the user is wearing the wearable device.

The first verification score may be calculated based on an audio feature extracted from the audio signal.

The second verification score may be calculated based on a vibration feature extracted from the vibration signal.

The second verification score may be calculated by filtering the vibration signal, restoring a high-frequency component of a filtered vibration signal, and removing noise from the filtered vibration signal.

The processor may be configured to perform the speaker verification based on whether the wearable device and the processor are connected and based on the first permission and the second permission.

According to an embodiment of the disclosure, a speaker verification method of an electronic device may include receiving an audio signal including a voice signal of a user, detecting a vibration signal generated by the user, determining a noise level included in the audio signal, calculating a verification score based on the noise level, the audio signal, and the vibration signal, and performing speaker verification for the user based on the verification score.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device, comprising:
a microphone configured to receive an audio signal comprising a voice of a user;
a sensor configured to detect a vibration signal generated by the user;
at least one processor; and
a memory configured to store an instruction executable by the at least one processor,
wherein the at least one processor is configured to:
determine a noise level included in the audio signal,
calculate a verification score based on the noise level, the audio signal, and the vibration signal, and
perform speaker verification for the user based on the verification score.

2. The electronic device of claim 1, wherein the at least one processor is further configured to:
determine the noise level by comparing a power of noise included in the audio signal and a predetermined noise threshold.

3. The electronic device of claim 1, wherein the at least one processor is further configured to:
calculate a first verification score comprised in the verification score based on the audio signal, and
calculate a second verification score comprised in the verification score based on the vibration signal.

4. The electronic device of claim 3, wherein the at least one processor is further configured to:
determine a first weight corresponding to the first verification score,
determine a second weight corresponding to the second verification score, and
perform the speaker verification for the user based on the first verification score, the first weight, the second verification score, and the second weight.

5. The electronic device of claim 4, wherein the at least one processor is further configured to:
determine the first weight and the second weight based on a neural network trained based on the noise level and a type of noise.

6. The electronic device of claim 4, wherein the at least one processor is further configured to:
determine whether the user is wearing the electronic device; and
determine the first weight and the second weight based on a result of the determination.

7. The electronic device of claim 3, wherein the at least one processor is further configured to:
extract an audio feature from the audio signal; and
calculate the first verification score based on the audio feature.

8. The electronic device of claim 3, wherein the at least one processor is further configured to:
extract a vibration feature from the vibration signal; and
calculate the second verification score based on the vibration signal.

9. The electronic device of claim 1, wherein the at least one processor is further configured to:
filter the vibration signal;
restore a high-frequency component of a filtered vibration signal; and
remove noise from the filtered vibration signal.

10. An electronic device, comprising:
a first microphone configured to receive an audio signal comprising a voice of a user;
a processor; and
a memory configured to store an instruction executable by the processor,
wherein the processor is configured to:
receive, from a wearable device, an indication whether to allow a first permission determined by a first verification score and a second verification score calculated based on an audio signal received through a second microphone of the wearable device, a noise level included in the audio signal, and a vibration signal generated by the user,
determine whether to allow a second permission based on a third verification score, and
perform speaker verification based on the first permission and the second permission.

11. The electronic device of claim 10, wherein the noise level is determined by comparing a power of noise included in the audio signal and a predetermined noise threshold.

12. The electronic device of claim 10, wherein the first verification score is calculated based on the audio signal and the second verification score is calculated based on the vibration signal.

13. The electronic device of claim 10, wherein whether to allow the first permission is determined based on a first weight corresponding to the first verification score and a second weight corresponding to the second verification score, and based on the first verification score and the second verification score.

14. The electronic device of claim 13, wherein the first weight and the second weight are determined based on a neural network trained based on the noise level and a type of noise.

15. The electronic device of claim 13, wherein the first weight and the second weight are determined based on whether the user is wearing the wearable device.

16. The electronic device of claim 12, wherein the first verification score is calculated based on an audio feature extracted from the audio signal.

17. The electronic device of claim 12, wherein the second verification score is calculated based on a vibration feature extracted from the vibration signal.

18. The electronic device of claim 10, wherein the second verification score is calculated by:
filtering the vibration signal;
restoring a high-frequency component of a filtered vibration signal; and
removing noise from the filtered vibration signal.

19. The electronic device of claim 10, wherein the processor is further configured to perform the speaker verification based on whether the wearable device and the processor are connected and based on the first permission and the second permission.

20. A speaker verification method of an electronic device, the method comprising:
receiving an audio signal comprising a voice signal of a user;
detecting a vibration signal generated by the user;
determining a noise level included in the audio signal;
calculating a verification score based on the noise level, the audio signal, and the vibration signal; and
performing speaker verification for the user based on the verification score.

21. A non-transitory computer-readable storage medium storing instructions that, when executed by a processor, cause the processor to perform the method of claim 20.

22. The method of claim 20, further comprising:
locking or unlocking the electronic device based on a result of the speaker verification.

23. The method of claim 22, wherein the locking or unlocking of the electronic device comprises locking or unlocking the electronic device based on a result of the speaker verification and a connection status of an external electronic device.

24. The method of claim 20, wherein the audio signal is received from an external electronic device.
